(19) United States
(12) Patent Application Publication
(10) Pub. No.: US 2026/0004259 A1
(43) Pub. Date: Jan. 1, 2026

(54) INFORMATION PROCESSING DEVICE

(71) Applicant: TOYOTA JIDOSHA KABUSHIKI KAISHA, Toyota-shi (JP)

(72) Inventors: Keisuke Isomura, Kariya-shi (JP); Tatsuhiko Sasaki, Toyota-shi (JP); Iwao Nitta, Nagoya-shi (JP); Aya Ohkubo, Nisshin-shi (JP); Sotaro Hayashi, Okazaki-shi (JP); Masahiro Kagami, Nagoya-shi (JP); Makoto Mizuguchi, Toyota-shi (JP); Kenta Kimura, Nagoya-shi (JP); Yasuhiro Kobatake, Nagoya-shi (JP)

(73) Assignee: TOYOTA JIDOSHA KABUSHIKI KAISHA, Toyota-shi (JP)

(21) Appl. No.: 19/027,775

(22) Filed: Jan. 17, 2025

(30) Foreign Application Priority Data
Jun. 26, 2024 (JP) 2024-102900

(51) Int. Cl. G06Q 10/30; G06Q 20/38; G06Q 30/02

(52) U.S. Cl. CPC G06Q 10/30; G06Q 20/389; G06Q 30/0278

(57) ABSTRACT

An information processing device that manages a transaction of a battery member of an in-vehicle battery. A registration of information on a first battery member that is a recycled battery member is received from a first business, a value of the first battery member is calculated based at least on an appraised value of a right the recycled battery member has, and the first business that provides the first battery member and the second business to which the first battery member is to be transferred are matched based on the value of the first battery member.

### CROSS-REFERENCE TO RELATED APPLICATION

This application claims priority to Japanese Patent Application No. 2024-102900 filed on Jun. 26, 2024, incorporated herein by reference in its entirety.

### BACKGROUND

### 1. Technical Field

The present disclosure relates to information processing devices.

### 2. Description of Related Art

Methods for reducing the cost of batteries for electrified vehicles have been considered. In this regard, for example, Japanese Unexamined Patent Application Publication No. 2020-126305 (JP 2020-126305 A) discloses a management method for reducing the cost of batteries for electrified vehicles.

### SUMMARY

The present disclosure provides a technique for properly appraising the value of a recycled battery member.

One aspect of the present disclosure is
an information processing device configured to manage a transaction of a battery member of an in-vehicle battery. The information processing device includes a control unit configured to
receive, from a first business, registration of information on a first battery member that is a recycled battery member,
calculate a value of the first battery member based at least on an appraised value of a right the recycled battery member has, and
match the first business that provides the first battery member with a second business to which the first battery member is to be transferred, based on the value of the first battery member.

Other aspects include a method that is performed by the above device, a program that causes a computer to perform the method, and a computer-readable storage medium storing the program in a non-transitory manner.

The present disclosure allows proper appraisal of the value of a recycled battery member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a system according to a first embodiment;

FIG. 2 is a configuration diagram of a transaction server and a business terminal according to an embodiment;

FIG. 3A shows an example of a transaction ledger stored in a transaction server;

FIG. 3B show an example of evaluation data stored in the transaction server;

FIG. 4 is a sequence diagram of a process of calculating an appraised value of a battery member;

FIG. 5 is a sequential diagram of a process for conducting a transaction of a battery member; and

FIG. 6 is a diagram for explaining a matching method in the second embodiment.

### DETAILED DESCRIPTION OF EMBODIMENTS

In recent years, an increasing number of vehicles have been equipped with a driving battery such as battery electric vehicle (BEV), plug-in hybrid electric vehicle (PHEV), and the like, and are capable of traveling using electricity as an energy source.

In addition, there is a technique of rebuilding a battery for driving (hereinafter referred to as an in-vehicle battery) removed from a used electrified vehicle. For example, the performance of the in-vehicle battery can be restored by disassembling the in-vehicle battery removed from the used battery electric vehicle and refining the removed material. The battery member is an element constituting an in-vehicle battery, and is, for example, a battery module, a battery cell, an electrode used in a battery cell, or the like. As electrified vehicle becomes more popular, it is assumed that such businesses will increase, and transactions of battery members will become more active among businesses.

Incidentally, in the future, it is assumed that recycling of the in-vehicle battery is mandatory. In-vehicle batteries may be harmful to the environment if they are not properly recycled. For this reason, for example, it is assumed in the future that, when manufacturing an in-vehicle battery, it is legally required to use a recycled battery member of a certain proportion or more in accordance with the scale of the business.

When a recycled battery member (hereinafter referred to as a recycled member) is required to be used at the time of manufacturing an in-vehicle battery, the recycled member is added with a new value that has not been previously used, that is, “the legal obligation can be fulfilled”.

However, there is no mechanism for evaluating the battery member in consideration of such a value in the transaction market of the battery member.

An information processing device according to the present disclosure provides a technique for solving such a problem.

An information processing device according to an aspect of the present disclosure is an information processing device that manages a transaction of a battery member constituting an in-vehicle battery, the information processing device comprising: a control unit configured to: receive, from a first business, registration of information regarding a first battery member that is a recycled battery member; calculate a value of the first battery member based at least on an appraised value of a right the recycled battery member has; and match the first business that provides the first battery member and a second business to which the first battery member is to be transferred, based on the value of the first battery member.

The information processing device according to the present disclosure is a device that manages a transaction of a battery member (for example, a battery cell, a component constituting a battery cell, etc.) between businesses. The transaction may be a transaction in which money is exchanged with the battery member, or a transaction in which the battery members are exchanged. When the battery members are replaced, the recycled battery members may be replaced, or the recycled battery members and the new battery members may be replaced.

Usually, the recycled battery member is less valuable than a new battery member. However, there are cases where a legal obligation can be fulfilled by using recycled battery members. In this case, the recycling member may be considered to have a predetermined right, and it is assumed that a value corresponding to the right (referred to herein as a credit) is added. The information processing device evaluates the first battery member in consideration of the added credit.

The information processing device may be a device that accepts registration of information on a battery member from a plurality of businesses that desire a transaction, matches businesses whose transaction conditions match, and provides each business with information for conducting the transaction.

The control unit may acquire the appraised value corresponding to the above-described value addition from, for example, an external device that manages recycling of the battery member. For example, if more obligations can be fulfilled by using a certain recycled battery member, the appraised value of the battery member will be higher.

It should be noted that the value of the first battery member may be calculated based further on the appraised value of the material included in the first battery member.

The value of the first battery member may also be calculated based further on the cost incurred to refine the material.

This makes it possible to more accurately estimate the value of the first battery member.

The second business may provide the second battery member and replace it with the first battery member. In this case, the control unit may receive registration of information regarding the second battery member from the second business and match the first business that provides the first battery member with the second business that provides the second battery member.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

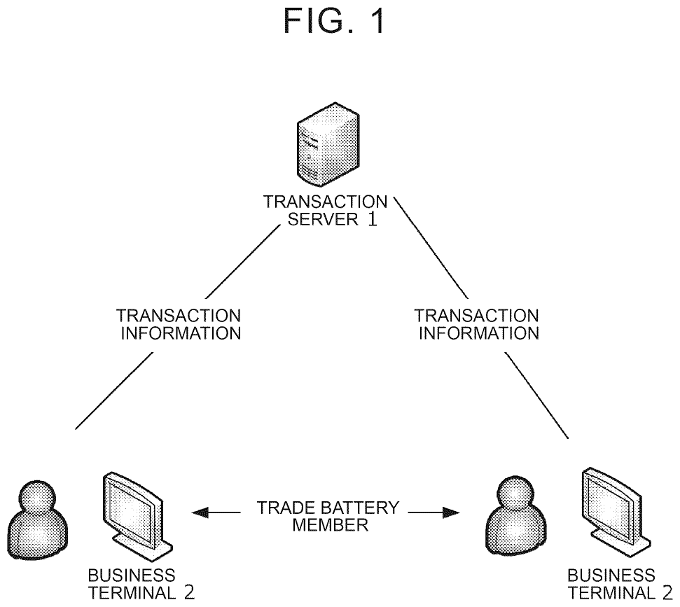

An outline of the system according to the first embodiment will be described with reference to FIG. 1. The system according to the present embodiment is a system in which a member (battery member) for manufacturing a battery pack designed for electrified vehicle is traded between vendors.

The battery pack is a unit in which a control computer (ECU) or the like is added to a driving battery of the vehicle. In order to manufacture a battery pack, a component such as a battery cell (referred to as a battery member) needs to be used. The battery member may be a new product or a recycled product. For example, a battery pack removed from a used vehicle may be disassembled and rebuilt to produce a recycled battery cell.

In a case where the use of a recycled product is required at a certain rate in a battery member used for manufacturing a battery pack, it is conceivable that the battery member is traded between the businesses. For example, a business that does not have a recycling facility for a battery member may purchase a battery member, which is a recycled product, from another business and incorporate the battery member into its own product. The system according to the first embodiment supports such transactions.

The transaction server 1 is a server device that provides information for trading battery members between businesses. The transaction server 1 matches the businesses based on the transaction information registered by the businesses, and provides information necessary for the transaction to each of the matched businesses.

In the present embodiment, the transaction server 1 further has a function of calculating an appraised value of the battery member related to the transaction. For example, before registering the transaction information, the business that wishes to conduct the transaction makes an inquiry to the transaction server 1 to obtain an appraised value of the battery member related to the transaction. As a result, the business can appropriately price the battery member related to the transaction.

The business terminal 2 is a terminal held by each business that trades a battery member. When conducting a transaction of a battery member, the business interacts with the transaction server 1 using the business terminal 2.

As shown in FIG. 1, a business that desires to conduct inter-business transaction with respect to a battery member uses the business terminal 2 to register information (transaction information) related to the transaction with the transaction server 1. The transaction information includes, for example, information about a battery member provided by the user, information about a desired sale amount, and the like.

The transaction server 1 matches the businesses based on the registered transaction information. For example, the transaction server 1 matches, with respect to the battery member registered by the business A, the business B who desires to purchase the battery member at a value equal to or greater than the desired amount presented by the business A.

The result of the matching is transmitted to the business terminal 2 of each business together with the information necessary for the transaction, and the transaction is executed. When the transaction involves the transfer of money or a battery member, the transaction server 1 may mediate the exchange of the information on the settlement and the information on the transfer of the battery member.

The transaction server 1 holds data (hereinafter referred to as evaluation data) serving as a reference for evaluating a battery member related to a transaction, and has a function of calculating an appraised value of the battery member based on the data. The appraised value can be calculated at an arbitrary timing. For example, in response to an inquiry from a business that intends to provide a battery member, the transaction server 1 calculates an appraised value of the battery member, and provides the result to the business. As a result, the business can appropriately price the battery member to be provided.

In the present embodiment, the evaluation data held by the transaction server 1 includes data for evaluating the rights of the recycled battery member. Based on the data, the transaction server 1 calculates an appraised value of rights held by the recycled battery member, and determines an appraised value of the entire battery member using the appraised value. Specific examples will be described later.

According to such a configuration, it becomes possible to estimate the value generated for “being a recycled product”, and it becomes possible to appropriately evaluate the battery member related to the transaction.

### Equipment Configuration

Next, the configuration of each device constituting the system will be described.

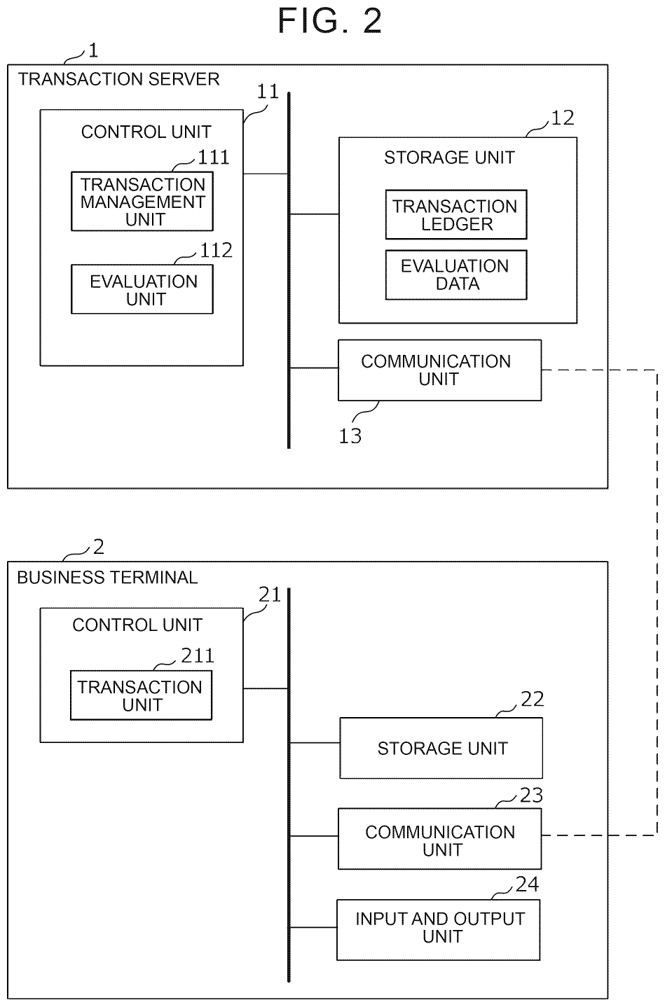

First, components of the transaction server 1 will be described. FIG. 2 is a diagram schematically illustrating an example of a configuration of the transaction server 1 and the business terminal 2.

The transaction server 1 can be configured as a computer including a processor (CPU, GPU, etc.), a main storage device (RAM, ROM, etc.), and a secondary storage device (EPROM, hard disk drive, removable medium, etc.). The secondary storage device stores an operating system (OS), various programs, various tables, and the like. Then, by executing the program stored therein, it is possible to realize each function (software module) that matches a predetermined purpose, as will be described later. However, part or all of the functions may be realized as a hardware module by, for example, hardware circuitry such as ASIC or FPGA.

The transaction server 1 includes a control unit 11, a storage unit 12, and a communication unit 13.

The control unit 11 is an arithmetic unit that realizes various functions of the transaction server 1 by executing a predetermined program. The control unit 11 can be realized by, for example, a hardware processor such as a CPU. In addition, the control unit 11 may be configured to include a RAM, ROM (Read Only Memory), a cache memory, and the like.

In the present embodiment, the control unit 11 included in the transaction server 1 includes a transaction management unit 111 and an evaluation unit 112 as software modules. The software modules may be implemented by executing programs stored in the storage unit 12 (described later) by the control unit 11 (CPU etc.). The information processing executed by the software module is synonymous with the information processing executed by the control unit 11 (CPU etc.).

The transaction management unit 111 manages the mutual transaction of the battery members between the businesses.

The transaction management unit 111 receives information (transaction information) related to the transaction of the battery member from the business terminal 2 of the business involved in the transaction, and stores the information in the transaction ledger in the storage unit 12. In the present embodiment, the term “transaction” refers to sale or purchase of a battery member or exchange of battery members.

The transaction management unit 111 provides, for example, a user interface for inputting transaction information to a business who wishes to be involved in a transaction.

The user interface may be a form for inputting details of a battery member related to a transaction (for example, details of a battery member provided by a business or a battery member desired to be purchased). The user interface may be a form for inputting a transaction condition (for example, whether the transaction is an exchange between members or a monetary transaction).

When the transaction information is input through the form, the transaction management unit 111 stores the transaction information in the transaction ledger.

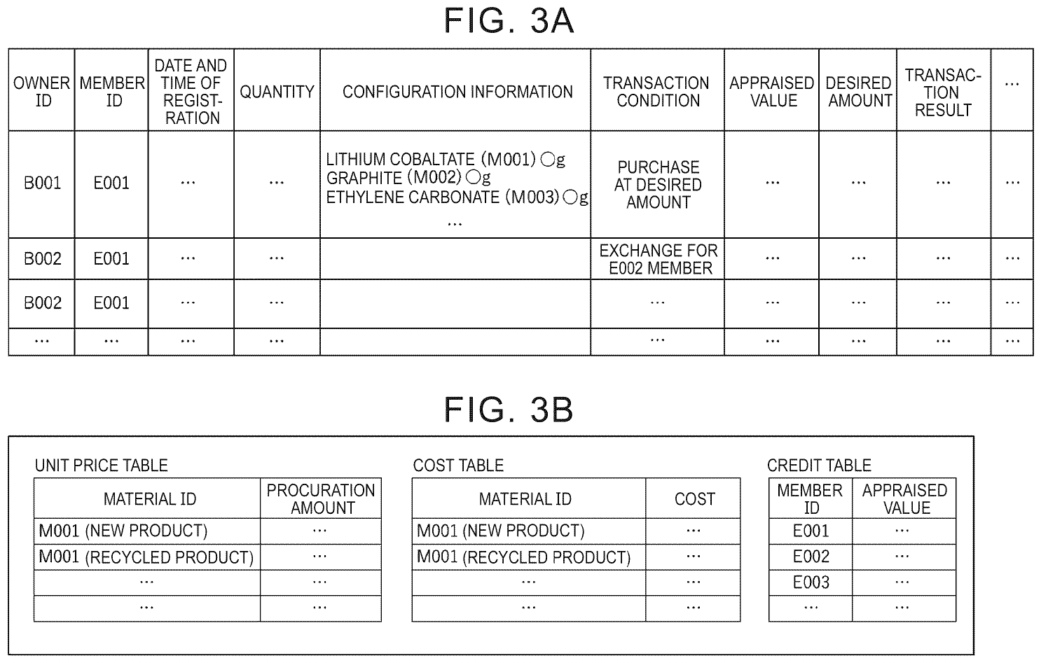

FIG. 3A is an example of a transaction ledger. The transaction ledger is a database for managing transactions. The transaction management unit 111 that has received the transaction information from the business terminal 2 generates a record corresponding to each business in the transaction ledger.

The transaction ledger includes fields of “owner ID,” “member ID,” “registered date and time,” “quantity,” “configuration information,” “transaction terms,” “appraised value,” “desired amount,” and “transaction result.”

In the owner ID field, an identifier representing a current owner of the battery member is stored. In the member ID field, an identifier that uniquely identifies the battery member is stored.

In the configuration information field, information about the material constituting the battery member is stored. For example, the battery member is made of a material such as a positive electrode, a negative electrode, an electrolyte, an electrolyte, or a separator. In the configuration information field, for example, information such as what kind of substance these materials contain is stored. By referring to such information, it is possible to appropriately calculate the appraised value of the battery member. In a case where the business involved in the transaction does not provide the battery member (such as a case where the business wishes to purchase the battery member by money), the information is not stored in the configuration information field.

In the transaction condition field, information indicating a transaction condition desired by the business related to the transaction is stored. The transaction conditions include, for example, types of transactions such as “trading by money” and “exchanging battery members”.

In the appraised value field, the appraised value of the battery member calculated by the evaluation unit 112 described later is stored. A method of evaluating the battery member will be described later. If the business involved in the transaction does not provide the battery member, no information is stored in the appraised value field.

In the desired amount field, a sale amount desired by a business that provides the battery member or a purchase amount desired by a business that purchases the battery member is stored. The desired amount may be an amount determined by the business based on the appraised value calculated by the evaluation unit 112.

When receiving the registration of the transaction information, the transaction management unit 111 may present the appraised value calculated by the evaluation unit 112 to the business and then receive an input of the desired amount from the business. For example, in a case where the appraised value calculated by the evaluation unit 112 is 50000 yen, the desired amount of sale may be 60000 yen.

In the transaction result field, information about the status of the transaction (for example, “unmatched”, “matched”, “transaction completed”, etc.) is stored.

The transaction management unit 111 matches the businesses whose transaction conditions match, based on the transaction information received from the business terminal 2.

The transaction management unit 111 extracts, from among the records included in the transaction ledger, a record in which the value of the transaction result field indicates that the transaction is not established, and performs matching between the businesses. Matching means generating a combination of businesses with matching transaction condition. In a case where there is a plurality of combinations of businesses whose transaction conditions match, the transaction management unit 111 may determine the combination of the businesses in consideration of other elements (for example, the desired amount, the residence of the business, etc.). In addition, these elements may be given a priority. For example, when matching is performed with priority given to the residence of the business, the businesses that are geographically close to each other are matched to each other, and the transportation cost of the battery member can be reduced. In addition, when the matching is performed with priority given to the amount of money, it is possible to match the businesses whose financial conditions are more favorable.

The result of the matching is transmitted to the business terminal 2, and a transaction (for example, exchange of money or a battery member) is executed.

The evaluation unit 112 performs an interaction with the business terminal 2 of the business that inputs the transaction information to calculate an appraised value of the battery member related to the transaction.

For example, an operator of the business terminal 2 presses an interface (button etc.) for calculating the appraised value while inputting the transaction information. The evaluation unit 112 calculates an appraised value of the battery member related to the transaction based on the input information (configuration information of the battery member).

In the present embodiment, the appraised value of the battery member is calculated by the following three types of criteria.

### (A) Value of Materials Contained in Battery Member

The battery member includes a plurality of materials such as, for example, lithium cobaltate, lithium nickelate, and graphite. In the present embodiment, the value of these materials is evaluated by the amount of procurement.

### (B) Cost of Manufacturing Battery Member

The cost of assembling the above-described material as a battery member. In the case where the battery member is a recycled product, the cost incurred in the step of taking out the material from the used battery pack and the cost incurred in the step of increasing the purity of the material (refining) are also included.

(C) Value of the Rights Associated with Recycled Battery Member

In the event that a legal obligation can be fulfilled by using a recycled battery member, the recycled member may be deemed to have a predetermined right (credit). Such a credit can be evaluated and quantified as an appraised value.

The evaluation unit 112 refers to data (evaluation data) stored in the storage unit 12 for evaluating the battery member, and calculates an appraised value of the battery member based on the three criteria described above. FIG. 3B is an example of evaluation data.

Evaluation data is divided into three tables: a unit price table, a cost table, and a credit table.

The unit price table is a table in which the value of the material constituting the battery member as a resource is defined. In the unit price table, for example, the amount of money per gram of material is defined by the procurement amount (appraised value). The unit price may vary depending on whether the material of interest is new or recycled. For example, recycled materials can be procured cheaper than new materials due to the refining cost.

The cost table is a table in which the cost of incorporating the material into the battery member is defined. When there is a common method for incorporating a material into a battery member, the cost of using the method may be estimated, and the result may be defined in a cost table. The cost table defines, for example, the cost per gram of material.

The cost of incorporating the material into the battery member may vary depending on whether the target material is a new material or a recycled material. For example, when recycled materials are used, an additional cost is required to refine the contaminated material. The costs defined in the cost table may include such a cost for refining the material.

Although not shown, an independent table may be defined in which the cost for refining the material is defined. The table may define the refining cost according to the type, amount, purity, and the like of the material.

The credit table is a table in which appraised values of rights (credits) the recycling members have are recorded. As described above, when an obligation to use a recycled member is imposed on a business, the recycled member may be considered credited. In the credit table, the appraised value of the credit is recorded. The credit appraised value may be calculated based on, for example, an actual price in the market, or may be obtained from an external device that manages recycling of the battery member.

The credit appraised value may be defined for each battery member or may be defined for each material constituting the battery member. In addition, in a case where the recycled battery member is considered to have a plurality of rights, an appraised value may be defined for each of the plurality of rights.

The result of the calculation by the evaluation unit 112 is presented to the business that provides the battery member. For example, the appraised value may be reflected in a form for inputting transaction information. The business may determine a desired amount when conducting a transaction based on the presented amount of money.

The storage unit 12 is means for storing information, and is configured to include a main storage device and an auxiliary storage device. The main storage device is a memory in which a program executed by the control unit 11 and data used by the control program are loaded. The auxiliary storage device is a device in which a program executed by the control unit 11 and data used by the control program are stored. The auxiliary storage device may store a package of programs executed by the control unit 11 as an application. Further, an operating system for executing these applications may also be stored. The program stored in the auxiliary storage device is loaded into the main storage device and executed by the control unit 11, so that the processing described below is performed.

The main storage device may include a RAM (Random Access Memory) or a ROM (Read Only Memory). The auxiliary storage device may include an EPROM (Erasable Programmable ROM and an HDD (Hard Disk Drive). Further, the auxiliary storage device may include a removable medium, that is, a portable recording medium.

The storage unit 12 stores the transaction ledger described above and evaluation data.

The communication unit 13 is a communication interface for connecting the transaction server 1 to a network. The communication unit 13 may be a wired communication interface or a wireless communication interface.

Next, the constituent elements of the business terminal 2 will be described. Similarly to the transaction server 1, the business terminal 2 can be configured as a computer including a processor (CPU, GPU, etc.), a main storage device (RAM, ROM, etc.), and a secondary storage device (EPROM, hard disk drive, removable medium, etc.).

The business terminal 2 includes a control unit 21, a storage unit 22, a communication unit 23, and an input and output unit 24.

The control unit 21 is an arithmetic unit that realizes various functions of the business terminal 2 by executing a predetermined program. The control unit 21 can be realized by, for example, a hardware processor such as a CPU. In addition, the control unit 21 may be configured to include a RAM, a ROM (Read Only Memory), a cache memory, and the like.

In the present embodiment, the control unit 21 included in the business terminal 2 includes a transaction unit 211 as a software module. The software module may be realized by executing a program stored in the storage unit 22, which will be described later, by a control unit 21 (CPU etc.). The information processing executed by the software module is synonymous with the information processing executed by the control unit 21 (CPU etc.).

The transaction unit 211 receives an input of information on a transaction of a battery member between the businesses (for example, information on a battery member to be provided, a transaction condition, etc.), and transmits the input information to the transaction server 1 as transaction information. Further, information related to the transaction transmitted from the transaction server 1 is acquired and output. The transaction unit 211 may receive an input of information about the result of the transaction (for example, the fact that the delivery of the battery member has been completed) and transmit the information to the transaction server 1.

The transaction unit 211 may output a user interface (for example, a form for inputting transaction information) based on the information transmitted from the transaction server 1.

The storage unit 22 is means for storing information, and is composed of a storage medium such as a RAM, a magnetic disk, or a flash memory. The storage unit 22 stores a program executed by the control unit 21, data used by the program, and the like.

The communication unit 23 is a communication interface for connecting the business terminal 2 to a network. The communication unit 23 may be a wired communication interface or a wireless communication interface.

The input and output unit 24 is a unit that receives an input from the operator of the business terminal 2 and presents information to the operator. Specifically, the input and output unit 24 includes a touch panel, a control unit for the touch panel, a liquid crystal display, and a control unit for the liquid crystal display. The touch panel and the liquid crystal display are composed of one touch panel display in the present embodiment. The input and output unit 24 may include a hardware interface such as a keyboard or a mouse.

The configuration shown in FIG. 2 is an example, and all or part of the functions shown in the figure may be executed using a specially designed circuit. Further, a program may be stored or executed by a combination of the main storage device and the auxiliary storage device other than the functions shown in the figure.

### Sequence Diagram

Next, processing executed by each device included in the system will be described.

The process can be roughly divided into a process in which each business registers information on a transaction in the transaction server 1 and a process in which the transaction server 1 matches the businesses and conducts the transaction.

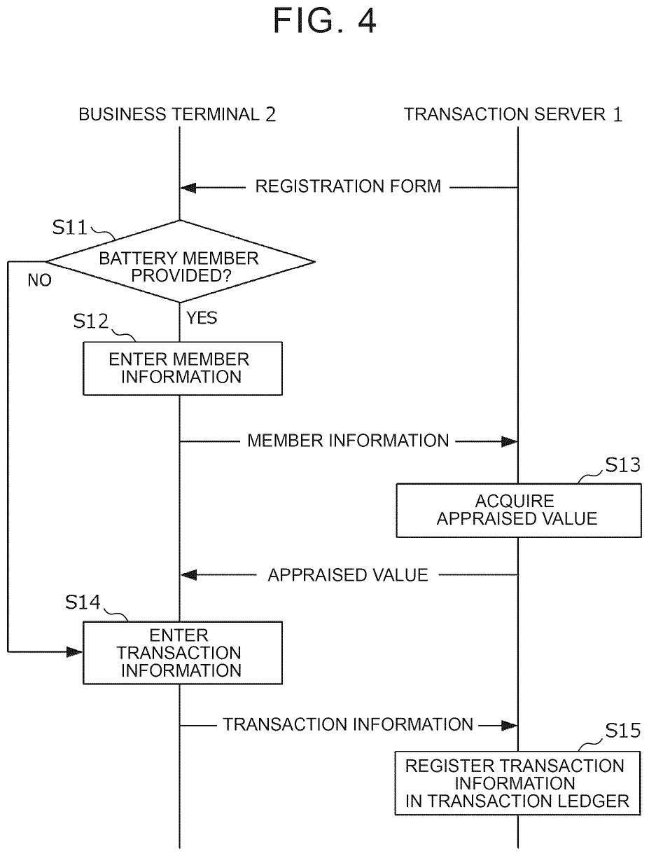

FIG. 4 is a sequence diagram of a process of registering information related to a transaction in the transaction server 1 by each business.

First, the transaction server 1 provides a user interface (registration form) for registering information related to a transaction to the business terminal 2.

Next, the business terminal 2 determines whether the battery member is provided (S11). For example, in a case where a business provides a battery member in a transaction (e.g., replacement or sale), this step is determined to be affirmative. In a case where the business does not provide the battery member in the transaction (e.g., purchase by money), this step is determined to be negative.

If an affirmative determination is made, the process proceeds to S12. If a negative determination is made, the process proceeds to S14.

In S12, the business terminal 2 receives input of information on the battery members held by each business (member information). As shown in FIG. 3A, the member information includes detailed configuration information about the battery member. At this stage, no information on transaction conditions or the like is input.

The inputted member information is transmitted to the transaction server 1, and the transaction server 1 (transaction manager 111) calculates an appraised value of the battery member related to the transaction based on the member information (S13). In this step, the evaluation unit 112 calculates three appraised values: (1) the procurement cost of the material included in the battery member; (2) the manufacturing cost of the battery member; and (3) the value of the credit associated with the battery member. Then, in this step, the sum of these values is estimated as an appraised value of the battery member.

The type and quantity of the material included in the battery member can be obtained from the configuration information included in the member information. The evaluation unit 112 calculates the above (1) by referring to the information and the unit price table of the evaluation data.

The manufacturing cost (2) of the battery member can be calculated by referring to the configuration information included in the member information and the cost table of the evaluation data.

The value of the credit (3) can be obtained by searching the credit table of the evaluation data using the identifier of the battery member as a key.

The evaluation unit 112 obtains an appraised value corresponding to the target battery member by summing these values. The transaction management unit 111 transmits the acquired appraised value to the business terminal 2. Accordingly, the business that provides the battery member can know the current appraised value of the target battery member, and can supply the battery member to the market after appropriate pricing.

In S14, the operator of the business terminal 2 inputs information (transaction information) related to the transaction other than the member information. The transaction information includes, for example, information related to designation of a battery member related to a transaction, a transaction condition (for example, designation of an object, designation of an amount of money, designation of a delivery date), and the like. In the transaction, when the business provides the battery member, the transaction information may include a desired sale amount of the battery member. When the business purchases the battery member, the transaction information may include a desired purchase amount of the battery member. The desired sale amount can be determined by the business (operator) based on the appraised value presented from the transaction server 1. The input transaction information is transmitted to the transaction server 1, and is registered into a transaction ledger (S15)

Next, a description will be given of a process of conducting a transaction between businesses.

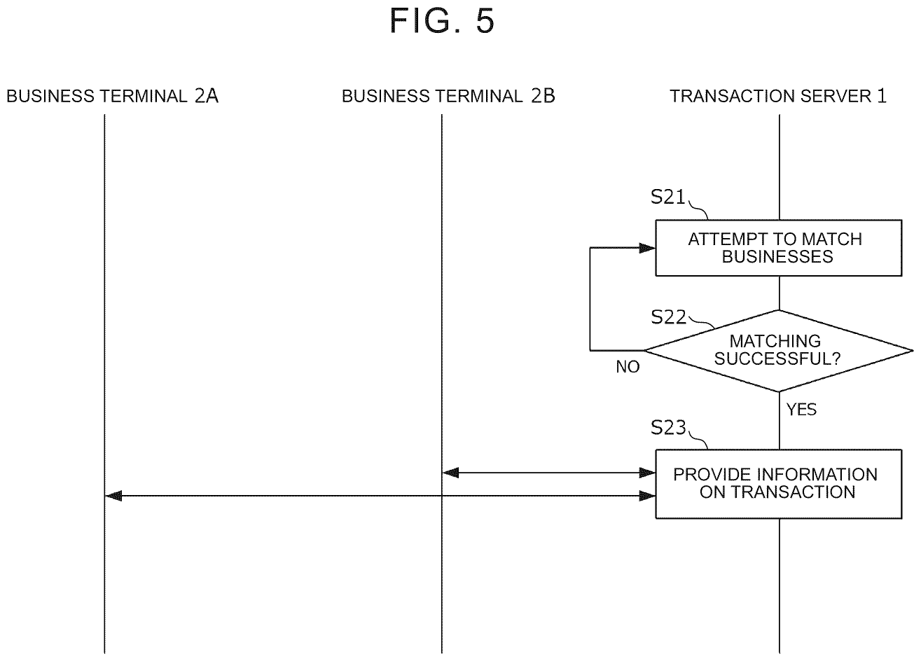

FIG. 5 is a sequence diagram of a process of trading a battery member between merchants using the transaction server 1.

Here, the business that conducts the transaction is referred to as the business A and the business B. In addition, the business terminal used by the business A is referred to as “business terminal 2A”, and the business terminal used by the business B is referred to as “business terminal 2B”.

First, in S21, the transaction server 1 try to match businesses based on the transaction ledger. In this step, a combination of businesses whose transaction conditions match is extracted, and a matching target is determined after evaluating whether the combination is appropriate as a combination that actually conducts the transaction.

When there is a plurality of candidates to be combined, the transaction server 1 may combine the businesses having better conditions. For example, the transaction server 1 may determine a combination of businesses that minimizes the transportation distance of the battery member.

Consequently, if the matching is successful (S22—Yes), the process proceeds to S23. When the matching cannot be performed (S22—No), the user waits for a predetermined period of time and attempts to perform the matching again. When the matching is not successful even after a predetermined period, the processing may be interrupted.

When the matching is successful, it can be considered that a transaction between the businesses has been established.

When the combination is determined, the transaction server 1 performs a process for conducting the transaction (S23). In this step, the transaction server 1 generates a guidance for the transaction and transmits the guidance to the business terminals 2A, 2B. The guidance may include information regarding a transaction partner, a method of delivering a battery member, a payment method, and the like.

When the transaction is completed, the business terminal 2 may transmit data indicating that the transaction is completed to the transaction server 1. The transaction server 1 can determine whether or not the delivery and settlement of the battery member have been completed based on the information received from the business terminals 2A, 2B. Note that the transaction server 1 may mediate the settlement. When the delivery and settlement of the battery member are completed, the transaction server 1 updates the transaction ledger and completes the transaction.

As described above, the transaction server 1 according to the present embodiment uses the evaluation data to calculate the appraised value of the battery member to be traded between the businesses, and then mediates the transaction of the battery member between the businesses.

In particular, in the calculation of the appraised value, the credit of the recycled battery member is added to the evaluation target. This makes it possible to accurately evaluate both a new battery member and a recycled battery member.

### Second Embodiment

In the first embodiment, the transaction server 1 may support inter-merchant transactions in which battery members are exchanged. On the other hand, there are cases where the transportation distance of the battery member can be shortened depending on the base of the business.

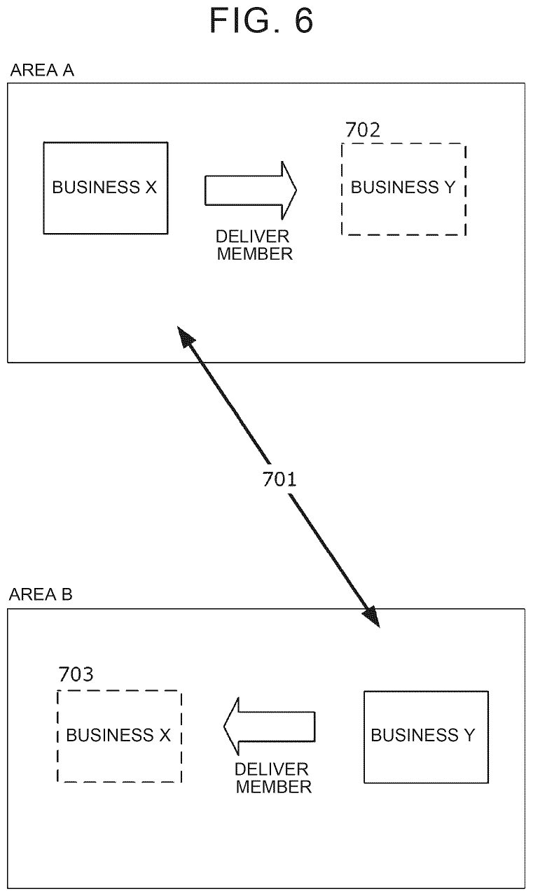

FIG. 6 is a diagram illustrating such a case. Here, it is assumed that the business X is present in the area A and the business Y is present in the area B. In this case, when the business X and the business Y replace the battery members owned by each other, the members need to move between the areas as indicated by reference numeral 701. Here, when the distance between the area A and the area B is far apart, a large transportation cost of the battery is required.

However, in a case where another base of the business that is a business partner is located near each business (e.g., in the same area), there is a case where the battery member can be delivered at the base. For example, in the case of the example of FIG. 6, there is a case where the base 702 of the business Y is located in the area A. In addition, there may be a base 703 of the business X in the area B. In this case, the business X may be able to deliver the battery member to the business Y at the base 702, and the business Y may be able to deliver the battery member to the business X at the base 703.

In the second embodiment, the transaction server 1 stores data on bases (e.g., a business office or a logistics center) of each business, and enables such a transaction by using the data.

The transaction server 1 according to the second embodiment is configured by further storing data (base data) related to bases of a plurality of businesses. The base data includes, for example, data related to an identifier of the business, an identifier of the base, an address of the base, a type of a battery member that can be delivered, and the like.

In addition, in the second embodiment, when the transaction server 1 performs matching between the businesses, a “base capable of delivering a battery member that is a transaction target” is extracted from the base data among the bases held by the mutual businesses. Then, supposing that the battery member is transported between the bases, the combination of businesses is evaluated (S21 in FIG. 5).

For example, the transaction server 1 may calculate a transportation cost in a case where the battery member is delivered at each site, and determine a combination of the businesses whose transportation cost is lower.

Alternatively, the first member held by the first business may be in the first area, and the second member held by the second business may be in the second area. In this case, the transaction server 1 may match the first business and the second business each having a base for each other in both the first area and the second area.

According to the second embodiment, it is possible to determine a combination of businesses such that the transportation distance of the battery member is shorter, and thus it is possible to contribute to a reduction in the manufacturing cost of the battery pack.

### Modifications

The above embodiment is merely illustrative, and the present disclosure may be appropriately modified and implemented without departing from the scope thereof. For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc-read only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device configured to manage a transaction of a battery member of an in-vehicle battery, the information processing device comprising a control unit configured to
receive, from a first business, registration of information on a first battery member that is a recycled battery member,
calculate a value of the first battery member based at least on an appraised value of a right the recycled battery member has, and
match the first business that provides the first battery member with a second business to which the first battery member is to be transferred, based on the value of the first battery member.

2. The information processing device according to claim 1, wherein:
the right is a right that allows fulfillment of a recycling obligation imposed on a business that manufactures the in-vehicle battery; and
the control unit is configured to acquire data representing the appraised value of the right from an external device, the external device being configured to manage recycling of the battery member.

3. The information processing device according to claim 1, wherein the control unit is configured to calculate the value of the first battery member based further on an appraised value of a material contained in the first battery member.

4. The information processing device according to claim 3, wherein the control unit is configured to calculate the value of the first battery member based further on a cost required to refine the material.

5. The information processing device according to claim 1, wherein:
the transaction is a transaction of exchanging the battery members; and
the control unit is configured to
receive registration of information on a second battery member from the second business, and
match the first business that provides the first battery member with the second business that provides the second battery member.
